(19) United States
(12) Patent Application Publication
(10) Pub. No.: US 2025/0238464 A1
(43) Pub. Date: Jul. 24, 2025

(54) Multistage Reasoning System for Processing a Query for a Video

(71) Applicant: Google LLC, Mountain View, CA (US)

(72) Inventors: Juhong Min, Pohang (KR); Shyamal Deep Buch, Grenoble (FR); Arsha Nagrani, Cambridge, MA (US); Minsu Cho, Pohang (KR); Cordelia Luise Schmid, Saint-Ismier (FR)

(21) Appl. No.: 19/034,237

(22) Filed: Jan. 22, 2025

Related U.S. Application Data
(60) Provisional application No. 63/623,778, filed on Jan. 22, 2024.

(51) Int. Cl. G06F 16/73; G06F 40/40; G06V 20/40

(52) U.S. Cl. CPC G06F 16/73; G06F 40/40; G06V 20/46

(57) ABSTRACT

A method includes generating, using at least one large language model, a set of event parsing instructions based on a query and an event parsing prompt. The method includes executing the event parsing instructions to generate event parsing data. The method includes generating, by the at least one large language model, a set of grounding instructions for a video based on a grounding prompt and the event parsing data. The method includes executing the grounding instructions to generate grounding data. The method includes generating, by the at least one large language model, a set of reasoning instructions based on a reasoning prompt and the grounding data. The method includes executing the reasoning instructions to generate reasoning data. The method includes generating, by the at least one large language model, a response to the query based on the reasoning data.

### CROSS-REFERENCE TO RELATED APPLICATION

The present application claims the benefit of U.S. Provisional Patent Application No. 63/623,778, filed Jan. 22, 2024. The contents of which are hereby incorporated by reference in their entirety.

### BACKGROUND

Computer-vision applications can be used to analyze a video and respond to queries about the video. As a non-limiting example, a video may show a man petting a dog on the stomach and the dog kicking its hind legs. When the video is provided to a computer-vision application, the computer-vision application can analyze the video and process a query, such as “why is the dog kicking?”

Typically, computer-vision applications utilize end-to-end networks (e.g., models) to analyze the video and process queries. However, one challenge with using a typical end-to-end network to analyze the video is the “black-box” nature of the end-to-end network, leading to a lack of interpretability and compositional generalization. For videos in particular, it may be desirable for networks to have the ability to understand events at different temporal scales, which is challenging for existing end-to-end networks that typically analyze only a few frames of the video prior to generating a response to the query.

### SUMMARY

A natural-language query about a video is provided to a multistage modular reasoning model. The multistage modular reasoning model (e.g., a multistage large language model) includes an event parsing stage, a grounding stage, a reasoning stage, and a final prediction stage. In the event parsing stage, the query and an event parsing prompt are provided to the multistage modular reasoning model. The multistage modular reasoning model generates a set of event parsing application programming interface (API) calls that, when executed by a processor or a computer-vision application, results in the generation of event parsing data. The event parsing data is stored in an external memory that is accessible by processing components associated with each stage of the multistage modular reasoning model. In the grounding stage, the event parsing data and a grounding prompt are provided to the multistage modular reasoning model. The multistage modular reasoning model generates a set of grounding API calls that, when executed by the processor or the computer-vision application, results in the generation of grounding data. Execution of the set of grounding API calls may include identifying candidate frames of the video that are associated with the query. The grounding data is also stored in the external memory. In the reasoning stage, the grounding data and a reasoning prompt are provided to the multistage modular reasoning model. The multistage modular reasoning model generates a set of reasoning API calls that, when executed by the processor or the computer-vision application, results in generation of reasoning data. The reasoning data may include responses (e.g., answers) to sub-questions associated with the query. The reasoning data is stored in the external memory and is usable during the prediction stage to generate (e.g., predict) a response to the query.

In a first example embodiment, a method of processing a query associated with a video includes generating, using at least one large language model, a set of event parsing instructions based on the query and an event parsing prompt. The method also includes executing the set of event parsing instructions to generate event parsing data. The method also includes generating, by the at least one large language model, a set of grounding instructions for the video based on a grounding prompt and the event parsing data. The method also includes executing the set of grounding instructions to generate grounding data. The method also includes generating, by the at least one large language model, a set of reasoning instructions based on a reasoning prompt and the grounding data. The method also includes executing the set of reasoning instructions to generate reasoning data. The method also includes generating, by the at least one large language model, a response to the query based on the reasoning data.

In a second example embodiment, an apparatus includes a memory and a processor coupled to the memory. The processor is configured to generate, using at least one large language model, a set of event parsing instructions based on a query and an event parsing prompt. The processor is also configured to execute the set of event parsing instructions to generate event parsing data. The processor is also configured to generate, by the at least one large language model, a set of grounding instructions for a video based on a grounding prompt and the event parsing data. The processor is also configured to execute the set of grounding instructions to generate grounding data. The processor is also configured to generate, by the at least one large language model, a set of reasoning instructions based on a reasoning prompt and the grounding data. The processor is also configured to execute the set of reasoning instructions to generate reasoning data. The processor is also configured to generate, by the at least one large language model, a response to the query based on the reasoning data.

In a third example embodiment, a non-transitory computer-readable medium includes instructions that, when executed by a processor, cause the processor to perform operations. The operations include generating, using at least one large language model, a set of event parsing instructions based on a query and an event parsing prompt. The operations also include executing the set of event parsing instructions to generate event parsing data. The operations also include generating, by the at least one large language model, a set of grounding instructions for a video based on a grounding prompt and the event parsing data. The operations also include executing the set of grounding instructions to generate grounding data. The operations also include generating, by the at least one large language model, a set of reasoning instructions based on a reasoning prompt and the grounding data. The operations also include executing the set of reasoning instructions to generate reasoning data. The operations also include generating, by the at least one large language model, a response to the query based on the reasoning data.

In a fourth example embodiment, a system may include various means for carrying out each of the operations of the first example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates an example of a process for responding to a query associated with a video using a multistage modular reasoning model, in accordance with examples described herein.

FIG. 2 illustrates an example of instructions generated by the multistage modular reasoning model, in accordance with examples described herein.

FIG. 3 illustrates an example of an apparatus that hosts the multistage modular reasoning model, in accordance with examples described herein.

FIG. 4 is a diagram illustrating training and inference phases of a machine-learning model, in accordance with examples described herein.

FIG. 5 illustrates a flow chart, in accordance with examples described herein.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example,” “exemplary,” and/or “illustrative” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

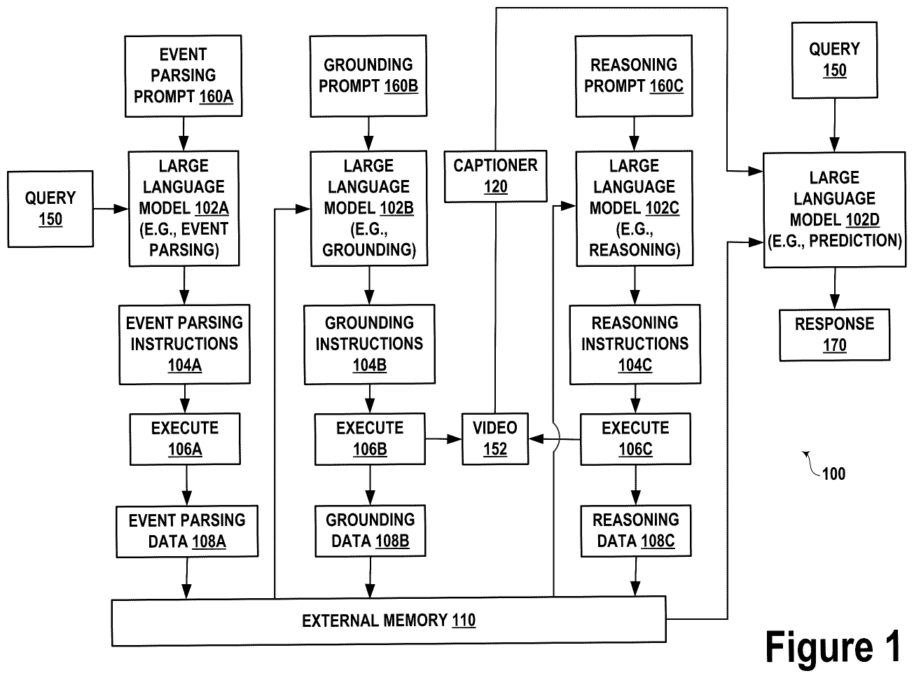

Particular embodiments are described herein with reference to the drawings. In the description, common features are designated by common reference numbers throughout the drawings. In some figures, multiple instances of a particular type of feature are used. Although these features are physically and/or logically distinct, the same reference number is used for each, and the different instances are distinguished by addition of a letter to the reference number. When the features as a group or a type are referred to herein (e.g., when no particular one of the features is being referenced), the reference number is used without a distinguishing letter. However, when one particular feature of multiple features of the same type is referred to herein, the reference number is used with the distinguishing letter. For example, referring to FIG. 1, multiple large language models are illustrated and associated with reference numbers 102A, 102B, 102C, and 102D. When referring to a particular one of these large language models, such as the large language model 102A, the distinguishing letter “A” is used. However, when referring to any arbitrary one of these large language models or to these large language models as a group, the reference number 102 is used without a distinguishing letter.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order. Unless otherwise noted, figures are not drawn to scale.

### I. Overview

The techniques described herein provide a multistage modular reasoning model

for video question and answering. For example, a user can provide a query (e.g., a natural language inquiry) about a video to the multistage modular reasoning model, and, based on the query, the multistage modular reasoning model can generate different application programming interface (API) calls (e.g., sets of instructions) that are executable by a processor (or application) to generate a response (e.g., an answer) to the query. In particular, the multistage modular reasoning model includes an event parsing stage that generates event parsing API calls, a grounding stage that generates grounding API calls, and a reasoning stage that generates reasoning API calls. At a final stage (e.g., a prediction stage), a large language model can predict the response to the query based on data generated by executing the API calls.

As used herein, the term “large language model” can include multistage large language models, multimodal large language models, transformer-based large language models, non-transformer-based large language models, or any other type of large language model. In particular, the term “large language model” can correspond to any artificial neural network(s) that learn statistical relationships from text during a computationally intensive training process.

The event parsing stage focuses on the initial analysis and processing of the query. The event parsing stage parses at the event-level rather than the word-level, focusing on higher-level video semantics while decomposing relationships and attributes for later stages (e.g., the grounding stage and the reasoning stage). During the event parsing stage, an event parsing prompt is provided to a large language model. The event parsing prompt conditions the multistage modular reasoning model to examine the query, perform parsing tasks such as detecting temporal hints and relationships (e.g., “in the beginning of the video”, “before”, “during”, etc.), detect sub-question types (e.g., location, description, explanation, etc.), and determine whether the language of the query suggests additional tool types, such as optical character recognition (OCR) tools. In response to the event parsing prompt, the multistage modular reasoning model produces the set of event parsing API calls based on the above-mentioned parsing tasks. The set of event parsing API calls can be indicative of a plan or program, which when executed, populates an external memory (shared across each stage) with relevant language-only data.

The grounding stage focuses on grounding identified events to resolve ambiguities and to direct tool-use in the reasoning stage to the temporal regions where the tools can be most effective. During the grounding stage, a grounding prompt is generated and provided to the multistage modular reasoning model along with outputs from the event parsing stage. The grounding stage conditions the large language model to identify candidate frames and temporal regions in the video with vision-language modules for entity detection and image-text alignment. In response to the grounding prompt, the multistage modular reasoning model generates the set of grounding API calls that, when executed, are designed to verify and resolve event ambiguity through visual grounding. The resulting plan or program is executed on the video and output grounding (spatially and temporally) is appended to the external memory.

The reasoning stage performs grounded reasoning before the final prediction. During the reasoning stage, a reasoning prompt is provided to the multistage modular reasoning model and data stored in the external memory from the previous stages (e.g., the event parsing stage and the grounding stage) can also be provided to the multistage modular reasoning model. The multistage modular reasoning model generates the set of reasoning API calls designed around reasoning sub-questions (which the large language model proposes) to unravel different aspects of the original query. The sub-questions focus on vision-language modules on the specific grounded regions of the video identified during the grounding stage. This localized, context-specific information is subsequently combined with a more general subsampled set of captions from frames across the video to form a comprehensive (temporally-sorted) basis for a final prediction large language model to output the final response.

Thus, according to the techniques described herein, the above-mentioned stages are distinct, yet interconnected. In particular, the above-mentioned stages employ one or more large language models that generate API calls that are tailored for specific subtasks. A shared external memory can be used to manage and store information across the above-mentioned stages. As a non-limiting example, the shared external memory can store data indicative of natural language events, grounded regions of the video, video captions, and intermediate tool outputs.

Processing complexity may be reduced by populating the external memory shared across each stage of the multistage modular reasoning model with data generated from each stage. As a non-limiting example, during the grounding stage, processing complexity may be reduced by bypassing the need for event parsing data to be forwarded (from the event parsing stage) to the processing components associated with the grounding stage. Instead, the processing components associated with the grounding stage can retrieve the event parsing data directly from the external memory shared across each stage.

By using different stages (e.g., by decomposition of a large language model into different stages), the multistage modular reasoning model can rely on smaller focused prompts that are able to process different aspects of an overall task, and incorporate grounding in the video to resolve ambiguities, and generate intermediate reasoning steps in a more effective manner than an ungrounded single-stage setting.

The techniques described herein can be applied in different scenarios. As non-limiting examples, the techniques described herein can be applied to (i) interpret live stream videos, (ii) interpret sports broadcasts, (iii) response to video search queries, (iv) understand the context of media (e.g., video) during playback, (v) interpret video captured by a robot, etc. In some scenarios, when the techniques described herein are used to interpret video captured by a robot, robot sensor data can be input to the multistage modular reasoning model to further improve response prediction (e.g., answer prediction). For example, if sensor data in the robot detects a gush of wind when somebody falls down in a video captured by the robot, the sensor data can be provided to the multistage modular reasoning model to provide context to a query, such as “why did the man fall down.”

### II. Example Process

FIG. 1 illustrates an example of a process 100 for responding to a query

associated with a video using a multistage modular reasoning model. The process 100 can be performed by a server, a user device, or both. In some scenarios, the user device can be a mobile phone, a personal digital assistant (PDA), a laptop computer, a tablet, etc.

According to the process 100, a multi-stage modular reasoning model for video question and answering is depicted. The process 100 includes three stages that are general to a video question and answering task across benchmarks and domains: (1) an event parsing stage, (2) a grounding stage, and (3) a reasoning stage. As described below, each stage is distinct, yet interconnected, and employs a large language model 102 that generates instructions 104 (e.g., a set of application programming interface (API) calls) tailored for specific subtasks associated with the stage. As further described below, an external memory 110 is shared across the three stages, including natural language events, grounded regions of a video 152, video captions, and intermediate tool outputs. After data from the three stages are generated and stored in the external memory 110, a large language model 102 can access the data stored in the external memory 110 to predict the response 170 to the query 150.

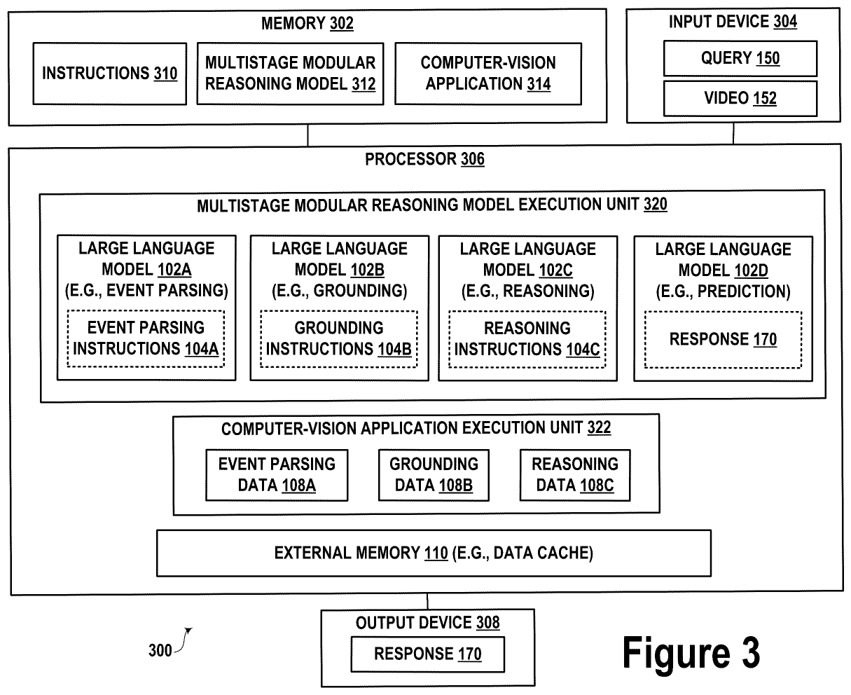

As depicted in FIG. 1, the process 100 utilizes at least one large language model 102 to generate instructions 104 that are executable by a processor, such as the processor 306 of FIG. 3. For example, FIG. 1 depicts a large language model 102A, a large language model 102B, a large language model 102C, and a large language model 102D. The large language model 102A is associated with the event parsing stage of the process 100, the large language model 102B is associated with the grounding stage of the process 100, and the large language model 102C is associated with the reasoning stage of the process 100. The large language model 102D can be associated with a prediction stage of the process 100 that is used to predict a response 170 to a query 150. Although four large language models 102A-102D are depicted in FIG. 1, in some implementations, the large language models 102A-102C can be integrated into a single large language model with shared parameters.

As described above and in greater detail below, the large language models 102A-102C can be configured to decompose the planning and execution of answering the query 150 into three stages: the event parsing stage, the grounding stage, and the reasoning stage. Through this decomposition, the multistage modular reasoning model described with respect to the process 100 relies on (i) smaller focused prompts for each stage, (ii) intermediate reasoning outputs (e.g., data 108) that are generated to handle different aspects of the overall task (e.g., responding to the query 150), and (iii) video groundings to resolve ambiguities and inform new intermediate steps in a more effective manner than an ungrounded single-stage setting.

In FIG. 1, the query 150 can be associated with the video 152. As a non-limiting example, the video 152 can depict a man skating on a sidewalk followed by the man sitting down and removing his skates. In this example, the query 150 can be a natural language question that asks “why did the man remove his skates”.

During the event parsing stage of the process 100, the query 150 and an event parsing prompt 160A are provided as inputs to the large language model 102A (e.g., an event parsing large language model). Based on the query 150 and the event parsing prompt 160A, a set of event parsing instructions 104A may be generated by the processor 306 using the large language model 102A. For example, the event parsing prompt 160A may condition the large language model 102A to examine the query 150, perform parsing tasks such as detecting temporal hints and relationships (e.g., “in the beginning of the video”, “before”, “during”, etc.), detect sub-question types (e.g., location, description, explanation, etc.), and determine whether the language of the query 150 suggests additional tool types, such as optical character recognition (OCR) tools. In response to the event parsing prompt 160A, the large language model 102A produces the set of event parsing instructions 104A (e.g., a set of event parsing API calls) based on the above-mentioned parsing tasks. The set of event parsing instructions 104A can be indicative of a plan or program, which when executed 106A, populates the external memory 110 (shared across each stage) with relevant language-only data.

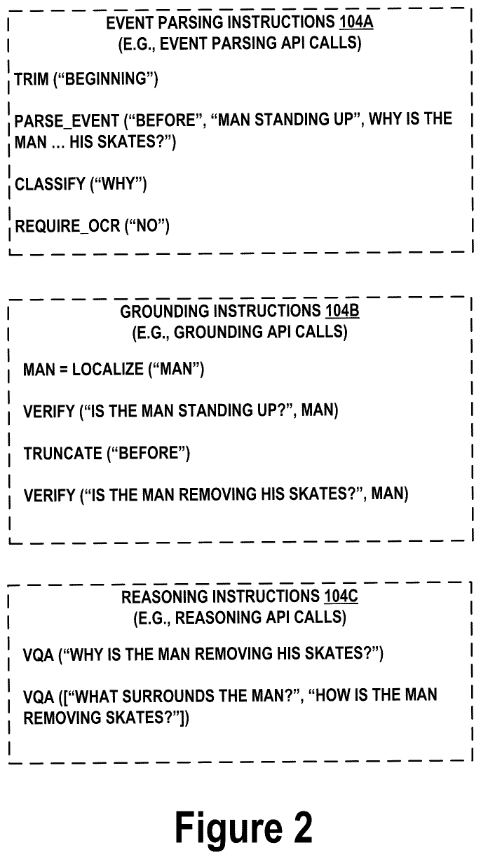

Referring to FIG. 2, a non-limiting example of the set of event parsing instructions 104A is depicted. According to the example in FIG. 2, the event parsing instructions 104A includes a “trim” instruction, a parse event instruction, a classification instruction, and an instruction indicating whether an OCR tool is required.

Referring back to FIG. 1, the processor 306 (or a computer-vision application 314) can execute 106A the set of event parsing instructions 104A to generate event parsing data 108A. Execution of the set of event parsing instructions 104A can cause the processor 306 (or the computer-vision application 314) to perform operations including (i) detecting temporal hint indicators in the query 150, (ii) detecting temporal relationship indicators in the query 150, (iii) detecting a question type of the query 150, (iv) determining whether the query 150 invokes use of one or more tools, etc. The event parsing data 108A is stored in the external memory 110 for future stages in the process 100. In the scenario where the processor 306 (or the computer-vision application 314) determines that the query 150 invokes use of one or more tools, such as an OCR tool, the processor 306 (or the computer-vision application 314) can use the tool during generation of the event parsing data 108A.

During the grounding stage of the process 100, a grounding prompt 160B and the event parsing data 108A are provided as inputs to the large language model 102B (e.g., a grounding large language model). Based on the grounding prompt 160B and the event parsing data 108A, a set of grounding instructions 104B may be generated by the processor 306 using the large language model 102B. The grounding prompt 160B conditions the large language model 102B to identify candidate frames and temporal regions in the video 152 with vision-language modules for entity detection and image-text alignment. In response to the grounding prompt 160B, the large language model 102B generates the set of grounding instructions 104B (e.g., a set of grounding API calls) that, when executed 106B, are designed to verify and resolve event ambiguity through visual grounding. Thus, the grounding stage focuses on grounding identified events to resolve ambiguities and to direct tool-use in the reasoning stage to the temporal regions where the tools can be most effective.

Referring to FIG. 2, a non-limiting example of the set of grounding instructions 104B is depicted. According to the example in FIG. 2, the grounding instructions 104B include an instruction to identify candidate frames in the video 152 where a man is localized, an instruction to verify in the candidate frames of the video 152 whether the man is standing up, an instruction to truncate all frames before the candidate frames in the video 152, and an instruction to verify that the man is removing his skates in the candidate frames of the video 152.

Referring back to FIG. 1, the processor 306 (or the computer-vision application 314) can execute 106B the set of grounding instructions 104B to generate grounding data 108B. Execution of the set of grounding instructions 104B can cause the processor 306 (or the computer-vision application 314) to perform operations including (i) identifying candidate frames of the video 152 that are associated with the query 150 or (ii) identifying temporal regions in the video 152 with one or more vision-language tools for entity detection and image-text alignment. The grounding data 108B is stored in the external memory 110 for future stages in the process 100.

A reasoning prompt 160C and at least the grounding data 108B are provided as inputs to the large language model 102C (e.g., a reasoning large language model). In some scenarios, the event parsing data 108A is also provided as an input to the large language model 102C. Based on at least the grounding data 108B and the reasoning prompt 160C, a set of reasoning instructions 104C may be generated by the processor 306 using the large language model 102C. For example, the large language model 102C generates the set of reasoning instructions 104C (e.g., a set of reasoning API calls) designed around reasoning sub-questions (which the large language model 102C proposes) to unravel different aspects of the query 150. The sub-questions focus on vision-language modules on the specific grounded regions of the video 152 identified during the grounding stage.

Referring to FIG. 2, a non-limiting example of the set of reasoning instructions 104C is depicted. According to the example in FIG. 2, the reasoning instructions 104C includes sub-questions, such as “why is the man removing his skates” and “what surrounds the man”.

Referring back to FIG. 1, the processor 306 (or the computer-vision application 314) can execute 106C the set of reasoning instructions 104C to generate reasoning data 108C (e.g., responses/answers to the sub-questions). Execution of the set of reasoning instructions 104C can cause the processor 306 (or the computer-vision application 314) to perform operations including generating responses/answers to sub-questions associated with the query 150. The reasoning data 108C is stored in the external memory 110.

The reasoning data 108C (e.g. localized, context-specific information) may be combined with captions from frames uniformly sampled by a captioner 120 and provided to the large language model 102D (e.g., a prediction large language model) along with the query 150. The large language model 102D can be used by the processor 306 to generate the response 170 to the query 150 (e.g., a final prediction).

The process 100 improves response prediction to the query 150 by utilizing different stages (e.g., an event parsing state, a grounding state, and a reasoning stage) to process different aspects of an overall task. For example, the large language model 102A is responsive to a small “focused” prompt (e.g., the event parsing prompt 160A) to parse the query 150 at the event-level rather than a word-level, the large language model 102B is responsive to a focused prompt (e.g., the grounding prompt 160B) to identify candidate frames in the video 152 associated with the query 150, and the large language model 102C is responsive to a focused prompt (e.g., the reasoning prompt 160C) to determine sub-questions, based on the candidate frames, that are used to accurately predict the response 170 to the query 150. Thus, the process 100 relies on smaller focused prompts, compared to a high-level prompt associated with a single-stage setting, that are able to (i) process different aspects of an overall task, (ii) incorporate grounding in the video 152 to resolve ambiguities, and (iii) generate intermediate reasoning steps in a more effective manner than the ungrounded single-stage setting.

In some embodiments, the process 100 may be used to retrieve evidence from the video 152 that is relevant to the query 150. For example, the process 100 may use the grounding stage to perform joint temporal grounding and question-answering. It should be appreciated that the process 100 may result in grounding accuracy metrics that surpass other techniques. In some embodiments, the process 100 may be used to generate a long, paragraph-level coherent summarization description of long video content. For example, the grounding stage of the process 100 may be employed to find multiple different relevant events for summarization, and the reasoning stage of the process 100 may be employed to ask for targeted event information that helps to create better overall video descriptions.

### III. Example Apparatus

FIG. 3 illustrates an example of an apparatus 300 that hosts the multistage modular reasoning model, in accordance with examples described herein. In particular, the apparatus 300 can be configured to perform the process 100 of FIG. 1. In some scenarios, the apparatus 300 corresponds to a server. In other scenarios, the apparatus 300 corresponds to a client device. In particular, the apparatus 300 can correspond to any mobile or stationary device that can detect and process audio. As non-limiting examples, the apparatus 300 can be a mobile phone, a personal digital assistant (PDA), a laptop computer, a tablet, etc.

The apparatus includes a processor 306, a memory 302 coupled to the processor 306, an input device 304 coupled to the processor 306, and an output device 308 coupled to the processor 306. The memory 302 can correspond to a non-transitory computer-readable medium that includes instructions 310 executable by the processor 306 to perform the operations described herein. Additionally, the memory 302 can store a multistage modular reasoning model 312 (e.g., instructions executable by the processor 306 to perform operations associated with the large language models 102 in the process 100) and a computer-vision application 314 (e.g., instructions executable by the processor 306 to perform the execute 106 function in the process 100).

The input device 304 can provide the query 150 and the video 152 to the processor 306. In some scenarios, the input device 304 can include a camera that is operable to capture the video 152. In some scenarios, the input device 304 can include a microphone that is operable to capture audio of a user asking the query 150. In some scenarios, the input device 304 can include a keypad (or similar device) operable to receive a textual input indicative of the query 150. In some scenarios, the input device 304 can include a receiver (or transceiver) operable to receive the query 150 and/or the video 152 from a remote device. Thus, although a single input device 304 is depicted in FIG. 3, it should be understood that the input device 304 can be one or more devices.

The processor 306 includes a multistage modular reasoning model execution unit 320, a computer-vision application execution unit 322, and the external memory 110 (e.g., a data cache). According to some embodiments, the multistage modular reasoning model execution unit 320 and/or the computer-vision application execution unit 322 can be implemented using dedicated hardware. As a non-limiting example, one or more components of the processor 306 can be implemented using one or more application-specific integrated circuits (ASICs) or one or more field programmable gate array (FPGA) devices. According to some embodiments, the multistage modular reasoning model execution unit 320 and/or the computer-vision application execution unit 322 can be implemented using software or firmware. As a non-limiting example, the multistage modular reasoning model execution unit 320 and/or the computer-vision application execution unit 322 can be implemented by the processor 306 executing the multistage modular reasoning model 312 and/or the computer-vision application 314, respectively, stored in the memory 302.

The multistage modular reasoning model execution unit 320 includes the large language models 102A-102D. As described with respect to FIG. 1, the large language model 102A can generate the event parsing instructions 104 (e.g., event parsing API calls) based on the event parsing prompt 160A and the query 150. The event parsing instructions 104A are provided to the computer-vision application execution unit 322. The computer-vision application execution unit 322 can be configured to execute 106A the event parsing instructions 104A to generate the event parsing data 108A. The event parsing data 108A is stored in the external memory 110.

The large language model 102B can generate the grounding instructions 104B (e.g., grounding API calls) based on the grounding prompt 160B and the event parsing data 108A. The grounding instructions 104B are provided to the computer-vision application execution unit 322. The computer-vision application execution unit 322 can be configured to execute 106B the grounding instructions 104B to generate the grounding data 108B. The grounding data 108B is stored in the external memory 110.

The large language model 102C can generate the reasoning instructions 104C (e.g., reasoning API calls) based on the reasoning prompt 160C and the grounding data 108B. The reasoning instructions 104C are provided to the computer-vision application execution unit 322. The computer-vision application execution unit 322 can be configured to execute 106C the reasoning instructions 104C to generate the reasoning data 108C. The reasoning data 108C is stored in the external memory 110.

The large language model 102D can predict (e.g., generate) the response 170 based at least on the reasoning data 108C. For example, the reasoning data 108C (e.g. localized, context-specific information) may be combined with captions from frames uniformly sampled by the captioner 120 and provided to the large language model 102D (e.g., a prediction large language model) along with the query 150. The large language model 102D can be used by the processor 306 to generate the response 170 to the query 150 (e.g., a final prediction).

The apparatus 300 improves response prediction to the query 150 by utilizing different stages (e.g., an event parsing state, a grounding state, and a reasoning stage) to process different aspects of an overall task. For example, the large language model 102A is responsive to a small “focused” prompt (e.g., the event parsing prompt 160A) to parse the query 150 at the event-level rather than a word-level, the large language model 102B is responsive to a focused prompt (e.g., the grounding prompt 160B) to identify candidate frames in the video 152 associated with the query 150, and the large language model 102C is responsive to a focused prompt (e.g., the reasoning prompt 160C) to determine sub-questions, based on the candidate frames, that are used to accurately predict the response 170 to the query 150. Thus, the apparatus 300 relies on smaller focused prompts, compared to a high-level prompt associated with a single-stage setting, that are able to (i) process different aspects of an overall task, (ii) incorporate grounding in the video 152 to resolve ambiguities, and (iii) generate intermediate reasoning steps in a more effective manner than the ungrounded single-stage setting.

### IV. Example Machine-Learning Process for Large Language Models

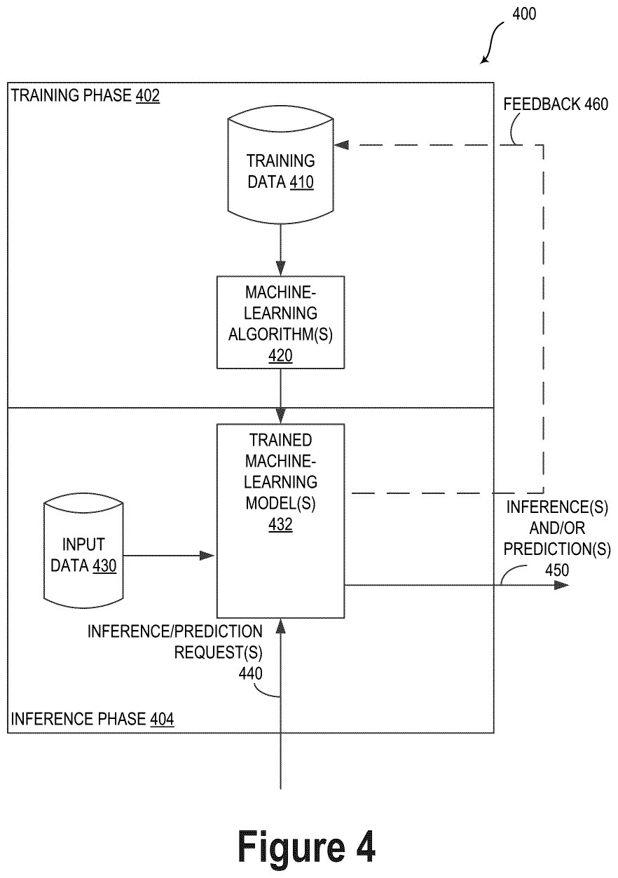

FIG. 4 shows a diagram 400 illustrating a training phase 402 and an inference phase 404 of trained machine-learning model(s) 432, in accordance with example embodiments. According to some examples, the trained machine-learning model(s) 432 can correspond to the large language model(s) 102. Some machine-learning techniques involve training one or more machine-learning algorithms on an input set of training data to recognize patterns in the training data and provide output inferences and/or predictions about (patterns in the) training data. The resulting trained machine-learning algorithm can be termed as a trained machine-learning model. For example, FIG. 4 shows the training phase 402 where machine-learning algorithm(s) 420 are being trained on training data 410 to become trained machine-learning model(s) 432. Then, during the inference phase 404, the trained machine-learning model(s) 432 can receive input data 430 and one or more inference/prediction requests 440 (perhaps as part of the input data 430) and responsively provide as an output one or more inferences and/or prediction(s) 450.

As such, the trained machine-learning model(s) 432 can include one or more models of machine-learning algorithm(s) 420. The machine-learning algorithm(s) 420 may include, but are not limited to: an artificial neural network (e.g., a herein-described convolutional neural networks, a recurrent neural network, a Bayesian network, a hidden Markov model, a Markov decision process, a logistic regression function, a support vector machine, a suitable statistical machine-learning algorithm, and/or a heuristic machine-learning system). The machine-learning algorithm(s) 420 may be supervised or unsupervised, and may implement any suitable combination of online and offline learning.

In some examples, the machine-learning algorithm(s) 420 and/or the trained machine-learning model(s) 432 can be accelerated using on-device coprocessors, such as graphic processing units (GPUs), tensor processing units (TPUs), digital signal processors (DSPs), and/or application specific integrated circuits (ASICs). Such on-device coprocessors can be used to speed up the machine-learning algorithm(s) 420 and/or the trained machine-learning model(s) 432. In some examples, the trained machine-learning model(s) 432 can be trained and executed to provide inferences on a particular computing device, and/or otherwise can make inferences for the particular computing device.

During the training phase 402, the machine-learning algorithm(s) 420 can be trained by providing at least the training data 410 as training input using unsupervised, supervised, semi-supervised, and/or reinforcement learning techniques. Unsupervised learning involves providing a portion (or all) of the training data 410 to the machine-learning algorithm(s) 420 and the machine-learning algorithm(s) 420 determining one or more output inferences based on the provided portion (or all) of the training data 410. Supervised learning involves providing a portion of the training data 410 to the machine-learning algorithm(s) 420, with the machine-learning algorithm(s) 420 determining one or more output inferences based on the provided portion of the training data 410, and the output inference(s) are either accepted or corrected based on correct results associated with the training data 410. In some examples, supervised learning of the machine-learning algorithm(s) 420 can be governed by a set of rules and/or a set of labels for the training input, and the set of rules and/or set of labels may be used to correct inferences of the machine-learning algorithm(s) 420.

Semi-supervised learning involves having correct results for part, but not all, of the training data 410. During semi-supervised learning, supervised learning is used for a portion of the training data 410 having correct results, and unsupervised learning is used for a portion of the training data 410 not having correct results. Reinforcement learning involves the machine-learning algorithm(s) 420 receiving a reward signal regarding a prior inference, where the reward signal can be a numerical value. During reinforcement learning, the machine-learning algorithm(s) 420 can output an inference and receive a reward signal in response, where the machine-learning algorithm(s) 420 are configured to try to maximize the numerical value of the reward signal. In some examples, reinforcement learning also utilizes a value function that provides a numerical value representing an expected total of the numerical values provided by the reward signal over time. In some examples, the machine-learning algorithm(s) 420 and/or the trained machine-learning model(s) 432 can be trained using other machine-learning techniques, including but not limited to, incremental learning and curriculum learning.

In some examples, the machine-learning algorithm(s) 420 and/or the trained machine-learning model(s) 432 can use transfer learning techniques. For example, transfer learning techniques can involve the trained machine-learning model(s) 432 being pre-trained on one set of data and additionally trained using the training data 410. More particularly, the machine-learning algorithm(s) 420 can be pre-trained on data from one or more computing devices and a resulting trained machine-learning model provided to a particular computing device, where the particular computing device is intended to execute the trained machine-learning model during the inference phase 404. Then, during the training phase 402, the pre-trained machine-learning model can be additionally trained using the training data 410, where the training data 410 can be derived from kernel and non-kernel data of the particular computing device. This further training of the machine-learning algorithm(s) 420 and/or the pre-trained machine-learning model using the training data 410 of the particular computing device's data can be performed using either supervised or unsupervised learning. Once the machine-learning algorithm(s) 420 and/or the pre-trained machine-learning model has been trained on at least the training data 410, the training phase 402 can be completed. The trained resulting machine-learning model can be utilized as at least one of the trained machine-learning model(s) 432.

In particular, once the training phase 402 has been completed, the trained machine-learning model(s) 432 can be provided to a computing device, if not already on the computing device. The inference phase 404 can begin after training the machine-learning model(s) 432 are provided to the particular computing device.

During the inference phase 404, the trained machine-learning model(s) 432 can receive the input data 430 and generate and output one or more corresponding inferences and/or prediction(s) 450 about the input data 430. As such, the input data 430 can be used as an input to the trained machine-learning model(s) 432 for providing corresponding inference(s) and/or prediction(s) 450 to kernel components and non-kernel components. For example, the trained machine-learning model(s) 432 can generate inference(s) and/or prediction(s) 450 in response to one or more inference/prediction requests 440. In some examples, the trained machine-learning model(s) 432 can be executed by a portion of other software. For example, the trained machine-learning model(s) 432 can be executed by an inference or prediction daemon to be readily available to provide inferences and/or predictions upon request. The input data 430 can include data from the particular computing device executing the trained machine-learning model(s) 432 and/or input data from one or more computing devices other than the particular computing device.

If the trained machine-learning model 432 corresponds to the large language model(s) 102, the input data 430 can include data associated with different queries 150 or prompts 160. Other types of input data are possible as well. Inference(s) and/or prediction(s) 450 can include other output data produced by the trained machine-learning model(s) 432 operating on the input data 430 (and the training data 410). In some examples, the trained machine-learning model(s) 432 can use output inference(s) and/or prediction(s) 450 as input feedback 460. The trained machine-learning model(s) 432 can also rely on past inferences as inputs for generating new inferences.

Convolutional neural networks and/or deep neural networks used herein can be an example of the machine-learning algorithm(s) 420. After training, the trained version of a convolutional neural network can be an example of the trained machine-learning model(s) 432. In this approach, an example of the one or more inference/prediction requests 440 can be a request to generate different sets of instructions 104 or predict the response 170 to the query 150.

### V. Additional Example Operations

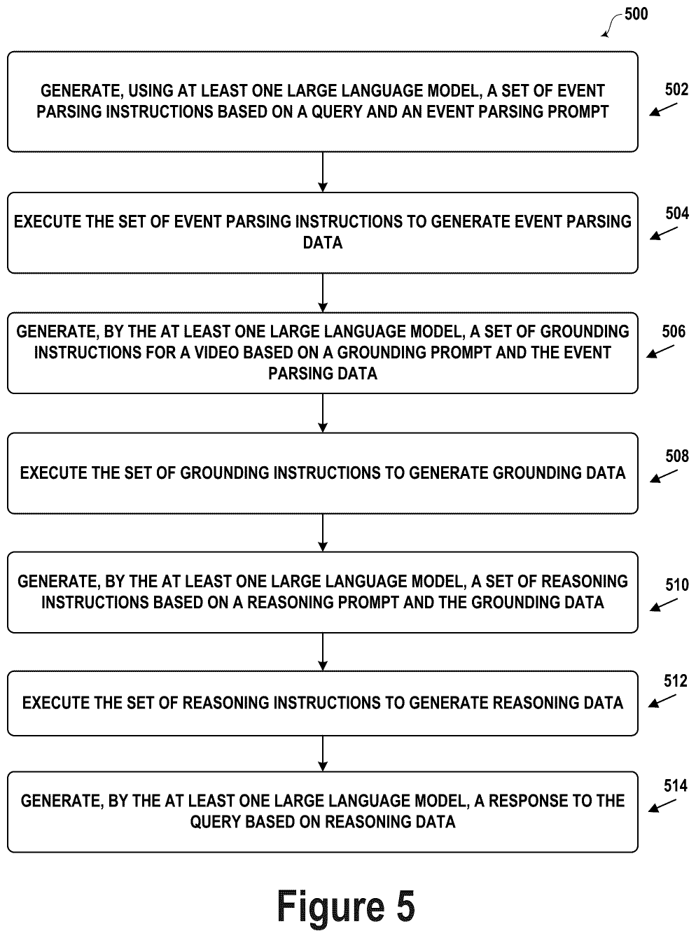

FIG. 5 illustrates a flow chart of a method 500 related to a new technology. The method 500 may be carried out by the apparatus 300 among other possibilities. The embodiments of FIG. 5 may be simplified by the removal of any one or more of the features shown therein. Further, these embodiments may be combined with features, aspects, and/or implementations of any of the previous figures or otherwise described herein.

The method 500 includes generating, using at least one large language model, a set of event parsing instructions based on a query and an event parsing prompt, at block 502. For example, referring to FIG. 1, the set of event parsing instructions 104A are generated, using the large language model 102A, based on the query 150 and the event parsing prompt 160A. According to one implementation of the method 500, the query 150 is expressed in natural language.

The method 500 also includes executing the set of event parsing instructions to generate event parsing data, at block 504. For example, the computer-vision application execution unit 322 executes the set of event parsing instructions 104A to generate the event parsing data 108A.

The method 500 also includes generating, by the at least one large language model, a set of grounding instructions for a video based on a grounding prompt and the event parsing data, at block 506. For example, referring to FIG. 1, the set of grounding instructions 104B for the video 152 (e.g., that are executed on the video 152) are generated, by the at least one large language model 102B, based on the grounding prompt 160B and the event parsing data 108A.

The method 500 also includes executing the set of grounding instructions to generate grounding data, at block 508. For example, the computer-vision application execution unit 322 executes the set of grounding instructions 104B to generate the grounding data 108B.

The method 500 also includes generating, by the at least one large language model, a set of reasoning instructions based on a reasoning prompt and the grounding data, at block 510. For example, referring to FIG. 1, the set of reasoning instructions 104C are generated, by the at least one large language model 102C, based on the reasoning prompt 160° C. and the grounding data 108B. According to one implementation of the method 500, the set of reasoning instructions 104C are further based on the event parsing data 108A.

The method 500 also includes executing the set of reasoning instructions to generate reasoning data, at block 512. For example, the computer-vision application execution unit 322 executes the set of reasoning instructions 104C to generate the reasoning data 108C.

The method 500 also includes generating, by the at least one large language model, a response to the query based on reasoning data, at block 514. For example, referring to FIG. 1, the response 170 to the query 150 is generated (e.g., predicted), by the at least one large language model 102D, based on the reasoning data 108C.

According to one implementation, the method 500 also includes storing the event parsing data, the grounding data, and the reasoning data at a memory that is accessible to the at least one large language model. For example, referring to FIG. 1, the event parsing data 108A, the grounding data 108B, and the reasoning data 108C at the external memory 110 that is accessible to the large language models 102.

According to one implementation of the method 500, the at least one large language model 102 corresponds to a single large language model with shared parameters.

According to one implementation of the method 500, the at least one large language model 102 includes (i) a first large language model 102A-102C that is used to generate the set of event parsing instructions 104, the set of grounding instructions 104B, and the set of reasoning instructions 104C, and (ii) a response prediction large language model 102D that is used to generate the response 170.

According to one implementation of the method 500, the at least one large language model 102 includes (i) a first large language model 102A that is used to generate the set of event parsing instructions 104A, (ii) a second large language model 102B that is used to generate the set of grounding instructions 104B, (iii) a third large language model 102C that is used to generate the set of reasoning instructions 104C, and (iv) a response prediction large language model 102D that is used to generate the response 170.

According to one implementation of the method 500, the set of event parsing instructions 104A correspond to a first set of application programming interface (API) calls, the set of grounding instructions 104B correspond to a second set of API calls, and the set of reasoning instructions 104C correspond to a third set of API calls.

According to one implementation of the method 500, execution of the set of event parsing instructions 104A by a processor 306, cause the processor 306 to perform operations comprising (i) detecting temporal hint indicators in the query 150, (ii) detecting temporal relationship indicators in the query 150, (iii) detecting a question type of the query 150, or (iv) determining whether the query invokes use of one or more tools. According to one implementation of the method 500, the one or more tools include an optical character recognition (OCR) tool.

According to one implementation of the method 500, execution of the set of grounding instructions 104B by a processor 306, cause the processor 306 to perform operations comprising (i) identifying candidate frames of the video 152 that are associated with the query 150 of (ii) identifying temporal regions in the video 152 with one or more vision-language tools for entity detection and image-text alignment.

According to one implementation of the method 500, execution of the set of reasoning instructions 104C by a processor 306, causes the processor 306 to perform operations comprising generating responses to one or more sub-questions associated with the query 150.

The method 500 of FIG. 5 improves response prediction to the query 150 by utilizing different stages (e.g., an event parsing state, a grounding state, and a reasoning stage) to process different aspects of an overall task. For example, the large language model 102A is responsive to a small “focused” prompt (e.g., the event parsing prompt 160A) to parse the query 150 at the event-level rather than a word-level, the large language model 102B is responsive to a focused prompt (e.g., the grounding prompt 160B) to identify candidate frames in the video 152 associated with the query 150, and the large language model 102C is responsive to a focused prompt (e.g., the reasoning prompt 160C) to determine sub-questions, based on the candidate frames, that are used to accurately predict the answer 170 to the query 150. Thus, the method 500 relies on smaller focused prompts, compared to a high-level prompt associated with a single-stage setting, that are able to (i) process different aspects of an overall task, (ii) incorporate grounding in the video 152 to resolve ambiguities, and (iii) generate intermediate reasoning steps in a more effective manner than the ungrounded single-stage setting.

### VI. Conclusion

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. In the figures, similar symbols typically identify similar components, unless context dictates otherwise. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical operations or actions in the method or technique. The program code and/or related data may be stored on any type of computer readable medium such as a storage device including random access memory (RAM), a disk drive, a solid state drive, or another storage medium.

The computer readable medium may also include non-transitory computer readable media such as computer readable media that store data for short periods of time like register memory, processor cache, and RAM. The computer readable media may also include non-transitory computer readable media that store program code and/or data for longer periods of time. Thus, the computer readable media may include secondary or persistent long term storage, like read only memory (ROM), optical or magnetic disks, solid state drives, compact-disc read only memory (CD-ROM), for example. The computer readable media may also be any other volatile or non-volatile storage systems. A computer readable medium may be considered a computer readable storage medium, for example, or a tangible storage device.

Moreover, a step or block that represents one or more information transmissions may correspond to information transmissions between software and/or hardware modules in the same physical device. However, other information transmissions may be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for the purpose of illustration and are not intended to be limiting, with the true scope being indicated by the following claims.

What is claimed is:

1. A method of processing a query associated with a video, the method comprising:
generating, using at least one large language model, a set of event parsing instructions based on the query and an event parsing prompt;
executing the set of event parsing instructions to generate event parsing data;
generating, by the at least one large language model, a set of grounding instructions for the video based on a grounding prompt and the event parsing data;
executing the set of grounding instructions to generate grounding data;
generating, by the at least one large language model, a set of reasoning instructions based on a reasoning prompt and the grounding data;
executing the set of reasoning instructions to generate reasoning data; and
generating, by the at least one large language model, a response to the query based on the reasoning data.

2. The method of claim 1, further comprising storing the event parsing data, the grounding data, and the reasoning data at a memory that is accessible to the at least one large language model.

3. The method of claim 1, wherein the at least one large language model corresponds to a single large language model with shared parameters.

4. The method of claim 1, wherein the at least one large language model comprises:
a first large language model that is used to generate the set of event parsing instructions, the set of grounding instructions, and the set of reasoning instructions; and
a response prediction large language model that is used to generate the response.

5. The method of claim 1, wherein the at least one large language model comprises:
a first large language model that is used to generate the set of event parsing instructions;
a second large language model that is used to generate the set of grounding instructions;
a third large language model that is used to generate the set of reasoning instructions; and
a response prediction large language model that is used to generate the response.

6. The method of claim 1, wherein the set of event parsing instructions correspond to a first set of application programming interface (API) calls, wherein the set of grounding instructions correspond to a second set of API calls, and wherein the set of reasoning instructions correspond to a third set of API calls.

7. The method of claim 1, wherein, execution of the set of event parsing instructions by a processor, cause the processor to perform operations comprising:
detecting temporal hint indicators in the query;
detecting temporal relationship indicators in the query;
detecting a question type of the query; or
determining whether the query invokes use of one or more tools.

8. The method of claim 7, wherein the one or more tools comprise an optical character recognition (OCR) tool.

9. The method of claim 1, wherein, execution of the set of grounding instructions by a processor, cause the processor to perform operations comprising:
identifying candidate frames of the video that are associated with the query; or
identifying temporal regions in the video with one or more vision-language tools for entity detection and image-text alignment.

10. The method of claim 1, wherein, execution of the set of reasoning instructions by a processor, causes the processor to perform operations comprising generating responses to one or more sub-questions associated with the query.

11. The method of claim 1, wherein the set of reasoning instructions are further based on the event parsing data.

12. The method of claim 1, wherein the query is expressed in natural language.

13. An apparatus comprising:
a memory; and
a processor coupled to the memory, the processor configured to:
generate, using at least one large language model, a set of event parsing instructions based on a query and an event parsing prompt;
execute the set of event parsing instructions to generate event parsing data;
generate, by the at least one large language model, a set of grounding instructions for a video based on a grounding prompt and the event parsing data;
execute the set of grounding instructions to generate grounding data;
generate, by the at least one large language model, a set of reasoning instructions based on a reasoning prompt and the grounding data;
execute the set of reasoning instructions to generate reasoning data; and
generate, by the at least one large language model, a response to the query based on the reasoning data.

14. The apparatus of claim 13, wherein the processor is further configured to store the event parsing data, the grounding data, and the reasoning data at an external memory that is accessible to the at least one large language model.

15. The apparatus of claim 13, wherein the at least one large language model corresponds to a single large language model with shared parameters.

16. The apparatus of claim 13, wherein the at least one large language model comprises:
a first large language model that is used to generate the set of event parsing instructions, the set of grounding instructions, and the set of reasoning instructions; and
a response prediction large language model that is used to generate the response.

17. The apparatus of claim 13, wherein the at least one large language model comprises:
a first large language model that is used to generate the set of event parsing instructions;
a second large language model that is used to generate the set of grounding instructions;
a third large language model that is used to generate the set of reasoning instructions; and
a response prediction large language model that is used to generate the response.

18. The apparatus of claim 13, wherein the set of event parsing instructions correspond to a first set of application programming interface (API) calls, wherein the set of grounding instructions correspond to a second set of API calls, and wherein the set of reasoning instructions correspond to a third set of API calls.

19. The apparatus of claim 13, wherein, execution of the set of event parsing instructions by the processor, cause the processor to perform operations comprising:
detecting temporal hint indicators in the query;
detecting temporal relationship indicators in the query;
detecting a question type of the query; or
determining whether the query invokes use of one or more tools.

20. A non-transitory computer-readable medium comprising instructions that, when executed by a processor, causes the processor to perform operations comprising:
generating, using at least one large language model, a set of event parsing instructions based on a query and an event parsing prompt;
executing the set of event parsing instructions to generate event parsing data;
generating, by the at least one large language model, a set of grounding instructions for a video based on a grounding prompt and the event parsing data;
executing the set of grounding instructions to generate grounding data;
generating, by the at least one large language model, a set of reasoning instructions based on a reasoning prompt and the grounding data;
executing the set of reasoning instructions to generate reasoning data; and
generating, by the at least one large language model, a response to the query based on the reasoning data.
